(19) United States
(12) Patent Application Publication
(10) Pub. No.: US 2012/0324161 A1
(43) Pub. Date: Dec. 20, 2012

(54) ELECTRONIC DEVICE AND METHOD FOR PERFORMING DATA BACKUP AND RECOVERY

(75) Inventors: XIANG CAO, Shenzhen City (CN); JUN-MIN CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/337,124

(22) Filed: Dec. 25, 2011

(30) Foreign Application Priority Data
Jun. 16, 2011 (CN) 201110162016.9

(51) Int. Cl. G06F 12/16

(52) U.S. Cl. 711/114; 711/E12.103

(57) ABSTRACT

In a method for performing data backup and recovery in an electronic device, the method initializes a redundant array of independent disk (RAID) card of the electronic device when the electronic device is started up, receives preset configuration information of the RAID card, and stores backup configuration information of the RAID card in a storage device. The method further sets a flag value of the RAID card as a first value if current configuration information of the RAID card are not identical to the backup configuration information when the electronic device is started up at a next time, restarts the electronic device, updates the current configuration information of the RAID card with the backup configuration information, sets the flag value as a second value, and restarts the electronic device.

### BACKGROUND

1. Technical Field

Embodiments of the present disclosure relate to data management technology, and particularly to an electronic device and method for performing data backup and recovery in an electronic device.

2. Description of Related Art

Redundant array of independent disk (RAID) cards are used to transfer data synchronously using a plurality of disk drivers of an electronic device (e.g., a server), to improve a transmission speed of the disk drivers. The RAID card includes a plurality of components, such as an input/output (I/O) processor, a small computer system interface (SCSI) controller, an SCSI connector, and a memory. However, if configuration information lost, it is hard to recover/retrieve the configuration information from the memory of the RAID card. Therefore, a more efficient method for performing data backup and recovery of configuration information of a RAID card in an electronic device is desired.

### BRIEF DESCRIPTION OF THE DRAWINGS

FIG. 1 is a block diagram of one embodiment of an electronic device including a data backup/recovery system.

FIG. 2 is a block diagram of function modules of the data backup/recovery system included in the electronic device.

FIG. 3 is a flowchart of one embodiment of a method for performing data backup and recovery of configuration information of a RAID card in an electronic device.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

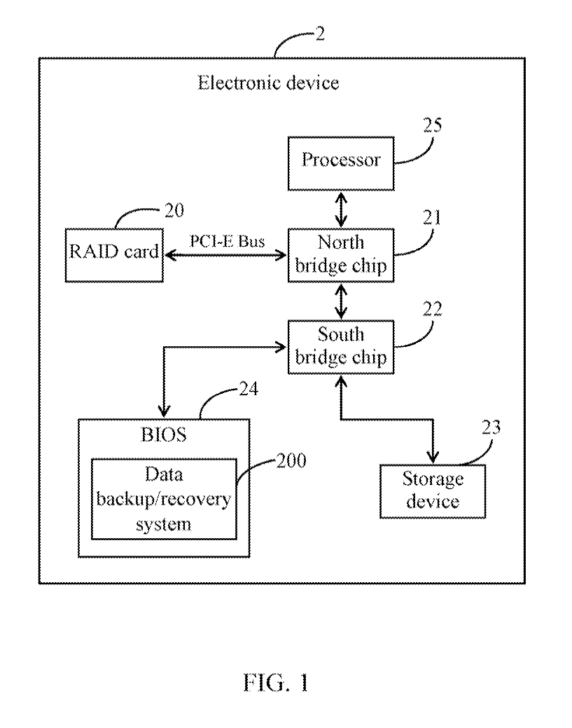

FIG. 1 is a block diagram of one embodiment of an electronic device 2 including a data backup/recovery system 200. In the embodiment, the data backup/recovery system 200 is stored in a basic input output system (BIOS) 24 of the electronic device 2. The electronic device 2 further includes a redundant array of independent disk (RAID) card 20, a north bridge chip 21, a south bridge chip 22, a storage device 23, and at least one processor 25. The electronic device 2 may be a computer, a server, a tablet device, a mobile phone, or any other computing device. FIG. 1 illustrates only one example of the electronic device 2 that may include more or fewer components than illustrated, or a different configuration of the various components in other embodiments.

The RAID card 20 connects with the north bridge chip 21 through a data line or a signal line, such as a peripheral component interconnect express (PCI-E) bus. The north bridge chip 21 connects with the south bridge chip 22 and the processor 25 through data lines or signal lines. The south bridge chip 22 connects the storage device 23 and the BIOS 24 through the data lines or signal lines.

The data backup/recovery system 200 stores a backup file of configuration information of the RAID card 20 in the storage device 23, and restores the configuration information of the RAID card 20 using the backup file when the configuration information of the RAID card 20 is lost or destroyed. In one embodiment, the data backup/recovery system 200 may include computerized instructions in the form of one or more programs that are executed by the at least one processor 25 and stored in the storage device 23 (or memory). A detailed description of the data backup/recovery system 200 will be given in the following paragraphs.

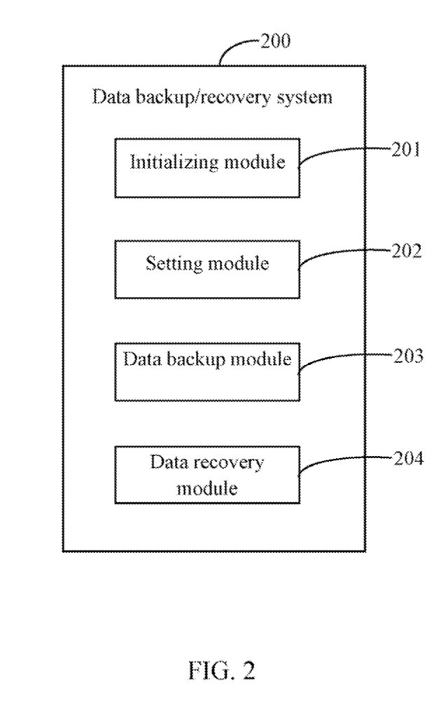

FIG. 2 is a block diagram of function modules of the data backup/recovery system 200 included in the electronic device 2. In one embodiment, the data backup/recovery system 200 may include one or more modules, for example, an initializing module 201, a setting module 202, a data backup module 203, and a data recovery module 204. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

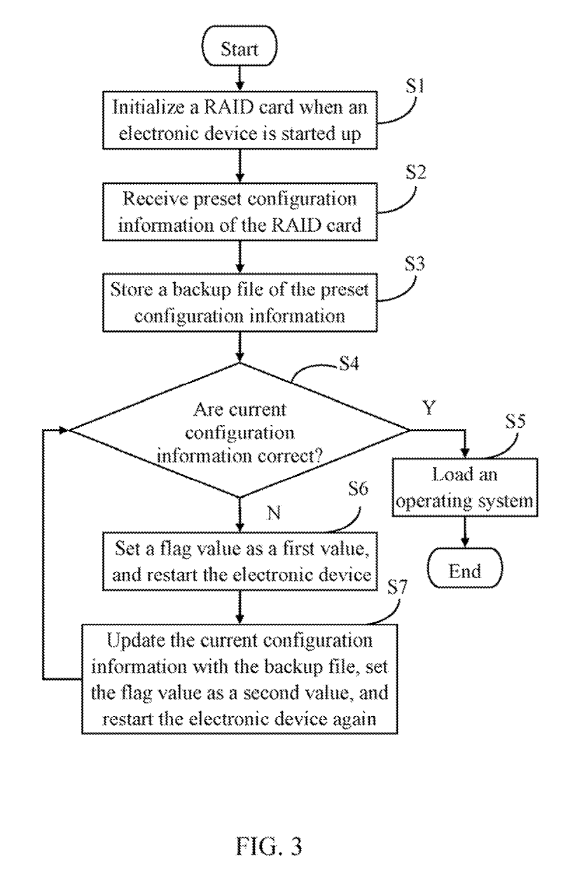

FIG. 3 is a flowchart of one embodiment of a method for performing data backup and recovery in an electronic device 2. Depending on the embodiment, additional blocks may be added, others removed, and the ordering of the blocks may be changed.

In block S1, the initializing module 201 initializes the RAID card 20 when the electronic device 2 is started up (i.e., turned on). For example, the initializing module 201 initializes the RAID card 20 to load a bootstrap program of the RAID card 20.

In block S2, the setting module 202 receives preset configuration information of the RAID card 20. For example, a user may press specified keys (e.g., Ctrl+Z) through an input device (e.g., a keyboard) of the electronic device to enter a user interface in order to set the configuration information of the RAID card 20. In one embodiment, the preset configuration information includes, but is not limited to, a RAID level (e.g., RAID 5 or RAID 10) of the electronic device 2, a number of hard disks in the electronic device 2, and a storage capacity of each hard disk.

In block S3, the data backup module 203 obtains backup configuration information of the RAID card 20 by storing the preset configuration information into a backup file, and stores the backup file in the storage device 23. For example, the backup file may be stored in a firmware of the storage device 23, the storage device 23 may be a NAND flash memory.

In block S4, the data recovery module 204 determines if current configuration information of the RAID card 20 are correct when the electronic device 2 is started up at a next time. If the current configuration information of the RAID card 20 are identical to the backup configuration information, the data recovery module 204 determines that the current configuration are correct, the procedure goes to block S5. If the current configuration information of the RAID card 20 are not identical to the backup configuration information, the data recovery module 204 determines that the current configuration are incorrect, the procedure goes to block S6.

In block S5, the data recovery module 204 loads an operating system of the electronic device 2, such as a WINDOWS OS, or a LINUX OS, for example.

In block S6, the data recovery module 204 sets a flag value of the RAID card 20 as a first value (e.g., Flag=0), and restarts the electronic device 2. In one embodiment, the flag value is used to determine whether block S4 is executed or not when the electronic device 2 is started up.

For example, if the flag value is the first value, the data recovery module 204 does not determine if the current configuration information of the RAID card 20 are correct (i.e., block S4 is not executed) when the electronic device 2 is started up. If the flag value is a second value (e.g., Flag=1), the data recovery module 204 determines if the current configuration information of the RAID card 20 are correct (i.e., block S4 is executed) when the electronic device 2 is started up. It should be understood that, an initial value of the flag value is the second value.

In block S7, the data recovery module 204 updates the current configuration information of the RAID card 20 with the backup configuration information, sets the flag value as the second value, and restarts the electronic device 2. Then the procedure returns to block S4 to continue to check whether the current configuration information of the RAID card 20 are correct or incorrect.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for performing data backup and recovery in an electronic device, the method comprising:
initializing a redundant array of independent disk (RAID) card of the electronic device when the electronic device is started up;
receiving preset configuration information of the RAID card;
obtaining backup configuration information of the RAID card by storing the preset configuration information into a backup file, and storing the backup file in a storage device of the electronic device;
determining if current configuration information of the RAID card are identical to the backup configuration information when the electronic device is started up at a next time;
setting a flag value of the RAID card as a first value upon the condition that the current configuration information of the RAID card are not identical to the backup configuration information, and restarting the electronic device;
updating the current configuration information of the RAID card with the backup configuration information, setting the flag value as a second value, and restarting the electronic device.

2. The method according to claim 1, further comprising:
loading an operating system of the electronic device upon the condition that the current configuration information of the RAID card are identical to the backup configuration information.

3. The method according to claim 1, wherein the preset configuration information comprise a RAID level of the electronic device, a number of hard disks in the electronic device, and a storage capacity of each of the hard disks.

4. The method according to claim 1, wherein the backup file is stored in a firmware of the storage device.

5. The method according to claim 1, wherein the flag value is used to determine whether the determining step needed to be executed or not when the electronic device is started up.

6. The method according to claim 5, wherein the determining step is not executed upon the condition that the flag value is the first value, the determining step is executed upon the condition that the flag value is the second value, which is an initial value of the flag value.

7. An electronic device, comprising:
a storage device;
at least one processor; and
one or more modules that are stored in the storage device and executed by the at least one processor, the one or more modules comprising:
an initializing module that initializes a redundant array of independent disk (RAID) card of the electronic device when the electronic device is started up;
a setting module that receives preset configuration information of the RAID card;
a data backup module that obtains backup configuration information of the RAID card by storing the preset configuration information into a backup file, and stores the backup file in a storage device of the electronic device;
a data recovery module that determines if current configuration information of the RAID card are identical to the backup configuration information when the electronic device is started up at a next time;
the data recovery module that sets a flag value of the RAID card as a first value upon the condition that the current configuration information of the RAID card are not identical to the backup configuration information, and restarts the electronic device;
the data recovery module that updates the current configuration information of the RAID card with the backup configuration information, sets the flag value as a second value, and restarts the electronic device.

8. The electronic device according to claim 7, wherein the data recovery module loads an operating system of the electronic device upon the condition that the current configuration information of the RAID card are identical to the backup configuration information.

9. The electronic device according to claim 7, wherein the preset configuration information comprise a RAID level of the electronic device, a number of hard disks in the electronic device, and a storage capacity of each of the hard disks.

10. The electronic device according to claim 7, wherein the backup file is stored in a firmware of the storage device.

11. The electronic device according to claim 7, wherein the flag value is used to determine whether the determining step needed to be executed or not when the electronic device is started up.

12. The electronic device according to claim 11, wherein the data recovery module does not execute the determining step upon the condition that the flag value is the first value, the data recovery module executes the determining step upon the condition that the flag value is the second value, which is an initial value of the flag value.

13. A non-transitory storage medium having stored thereon instructions that, when executed by a processor of an electronic device, causes the electronic device to perform a method for performing data backup and recovery, the method comprising:
initializing a redundant array of independent disk (RAID) card of the electronic device when the electronic device is started up;
receiving preset configuration information of the RAID card;
obtaining backup configuration information of the RAID card by storing the preset configuration information into a backup file, and storing the backup file in a storage device of the electronic device;
determining if current configuration information of the RAID card are identical to the backup configuration information when the electronic device is started up at a next time;
setting a flag value of the RAID card as a first value upon the condition that the current configuration information of the RAID card are not identical to the backup configuration information, and restarting the electronic device;
updating the current configuration information of the RAID card with the backup configuration information, setting the flag value as a second value, and restarting the electronic device.

14. The non-transitory storage medium according to claim 13, wherein the method further comprises:
loading an operating system of the electronic device upon the condition that the current configuration information of the RAID card are identical to the backup configuration information.

15. The non-transitory storage medium according to claim 13, wherein the preset configuration information comprise a RAID level of the electronic device, a number of hard disks in the electronic device, and a storage capacity of each of the hard disks.

16. The non-transitory storage medium according to claim 13, wherein the backup file is stored in a firmware of the storage device.

17. The non-transitory storage medium according to claim 13, wherein the flag value is used to determine whether the determining step needed to be executed or not when the electronic device is started up.

18. The non-transitory storage medium according to claim 17, wherein the determining step is not executed upon the condition that the flag value is the first value, the determining step is executed upon the condition that the flag value is the second value, which is an initial value of the flag value.

19. The non-transitory storage medium according to claim 13, wherein the medium is selected from the group consisting of a hard disk drive, a compact disc, a digital video disc, and a tape drive.
